(19) United States
(12) Patent Application Publication
(10) Pub. No.: US 2005/0245128 A1
(43) Pub. Date: Nov. 3, 2005

(54) Seamless cover case

(75) Inventors: Hsien-Yu Chiu, Taoyuan (TW); Ping-Chuan Chu, Taoyuan (TW)

Correspondence Address: TROXELL LAW OFFICE PLLC;Suite 1404, 5205 Leesburg Pike, Falls Church, VA, 22041, US

(73) Assignee: P-Two Industries Inc.

(21) Appl. No.: 10/890,093

(22) Filed: Jul. 14, 2004

(30) Foreign Application Priority Data
Apr. 30, 2004 (TW) 93206699

(51) Int. Cl. H01R 9/05

(52) U.S. Cl. 439/578

(57) ABSTRACT

A seamless cover case is mainly composed of base edge convex edge, bending section with several dividers, several position limiters, several positioning tabs, several ground tabs through a one-time stamping process. The base covered by the cover case has bumps, position limiting grooves and positioning grooves to fasten the cover case to the base and reduce manufacturing cost. Thus, cover strength and protection is enhanced.

### BACKGROUND OF THE INVENTION

1. Field of the Invention

The present invention especially refers to a seamless cover case by an integrated stamping process. It is to cover the base of ultra-fine wire coaxial connector and protect the base and transmitted electromagnetic wave.

2. Description of the Related Art

As shown in FIG. 1, the traditional ultra-fine wire coaxial connector consists of an insulative base 10′ and a frame cover case 20′ that has an opening on each side and can securely connect to the base 10′. The base 10′ has a concave section 11′ for connection to an ultra-fine wire coaxial male connector. At one end of the base 10′, there are several terminals 13′ for electrical connection to the terminals on the matching connector.

To securely connect the base 10′ to the cover case 20′, the base 10′ has a fastener 15′, a connecting section 17′ and a convex section 16′. The convex section 16′ can lock into a hole 21′ of the cover case 20′. The fastener 15′ and the connecting section 17′ lock into an opening 23′ of the cover case 20′, a drop-off section 27′, a connecting tab 28′ and a convex section 29′. This intends to securely fasten the cover case 20′ to the base 10′ by an elastic fastening mechanism between the convex section 29′ and the fastener 15′, so the cover case 20′ is not separated from the base 10′ even under forces. Similarly, due to connection between the drop-off section 27′ and the connecting section 17′, the cover case 20′ does not shift right or left and come off. Thus, secure connection between the base 10′ and the cover case 20′ can be achieved.

However, the traditional connector needed a complicated process including four processing steps like prototype stamping and hole 21′ punching to make a cover frame, a bent convex 29′ and a connecting tab 28′. This is the first shortcoming for the traditional connector.

Besides, in the process involving bending operation, stress variation is induced to reduce the strength. This is the second shortcoming.

Further, the traditional connector after bending needs a slot of opening 23′ for elasticity, which could easily cut the assembly workers. This is the third shortcoming.

Further, the traditional connector needs a concave section made in advance to facilitate bending operation. It adds extra manufacturing cost. This is the fourth shortcoming.

### SUMMARY OF THE INVENTION

The main objective of the present invention is primarily to provide a cover case through a one-time integrated stamping process, so the cover case has a structure that enables fastening itself to a base and also reducing manufacturing cost. Moreover, the cover case will have improved cover strength and protective ability.

### BRIEF DESCRIPTION OF THE DRAWINGS

FIG. 1 is the three-dimensional disassembly diagram for a traditional connector.

FIG. 2 is the three-dimensional disassembly diagram for the cover case and the base for the present invention.

FIG. 3 is the three-dimensional assembly diagram for the cover case and the base for the present invention.

FIG. 4 is the three-dimensional diagram for the cover case for the present invention.

FIG. 5 is the enlarged diagram of A area in FIG. 4.

FIG. 6 is the enlarged diagram of B area in FIG. 4.

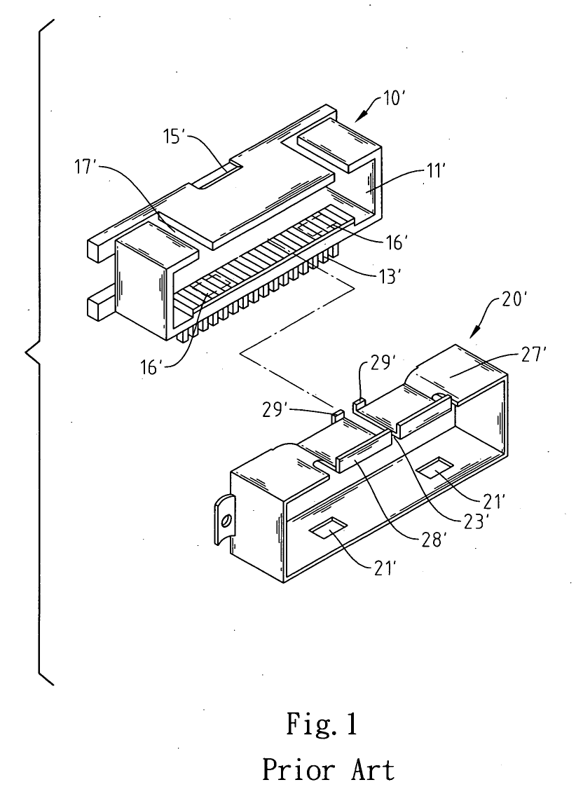

### DETAILED DESCRIPTION OF THE INVENTION

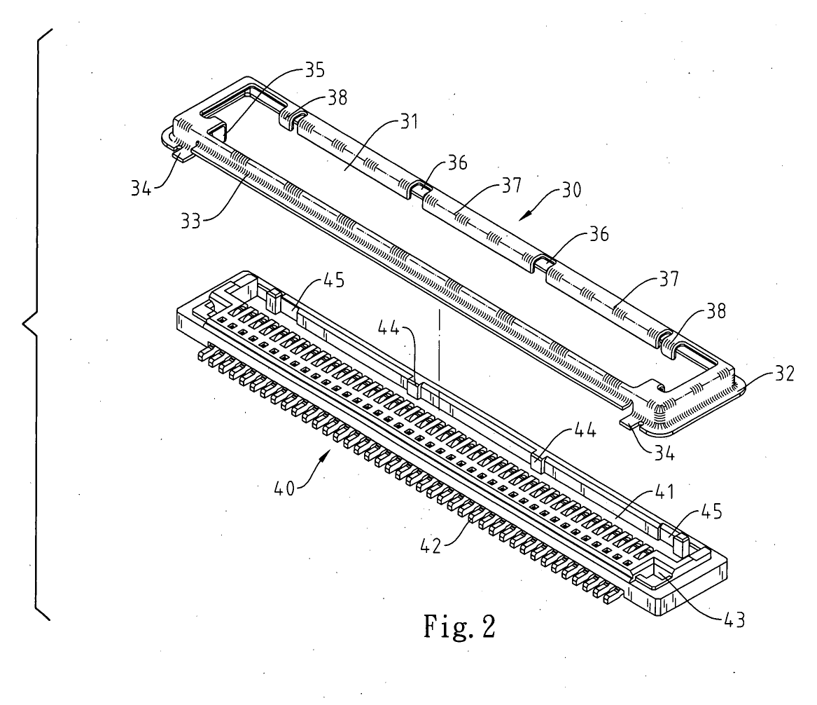

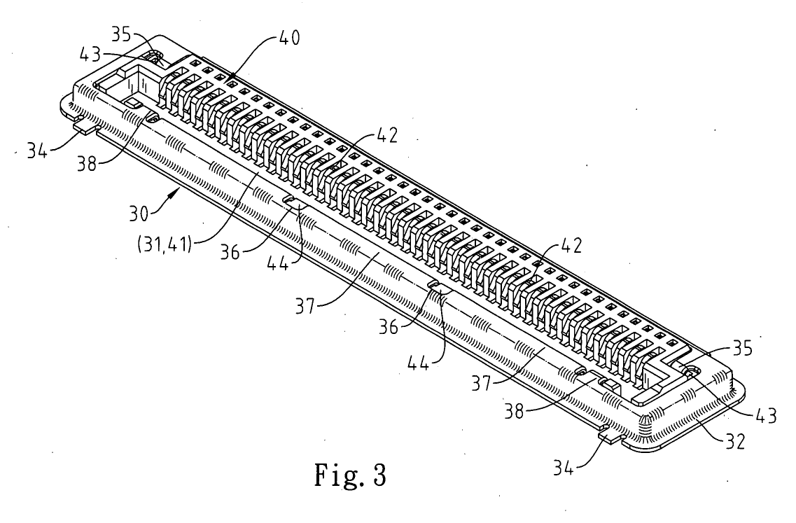

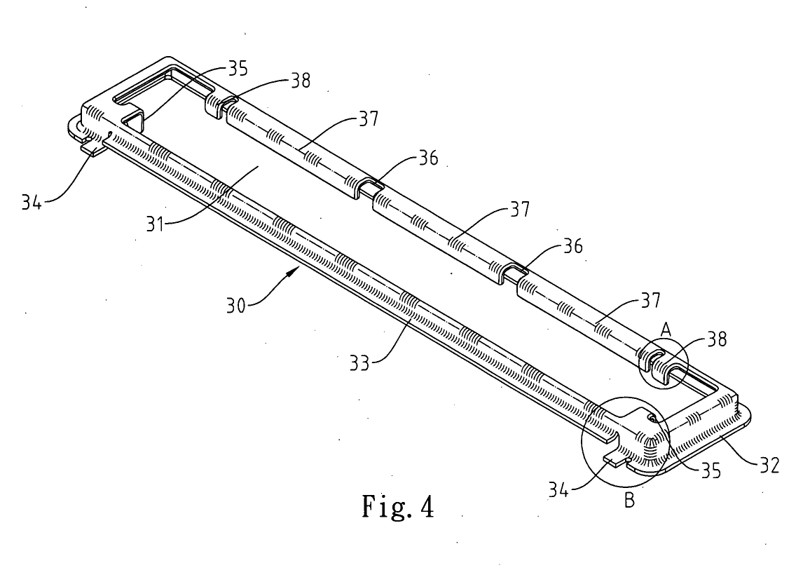

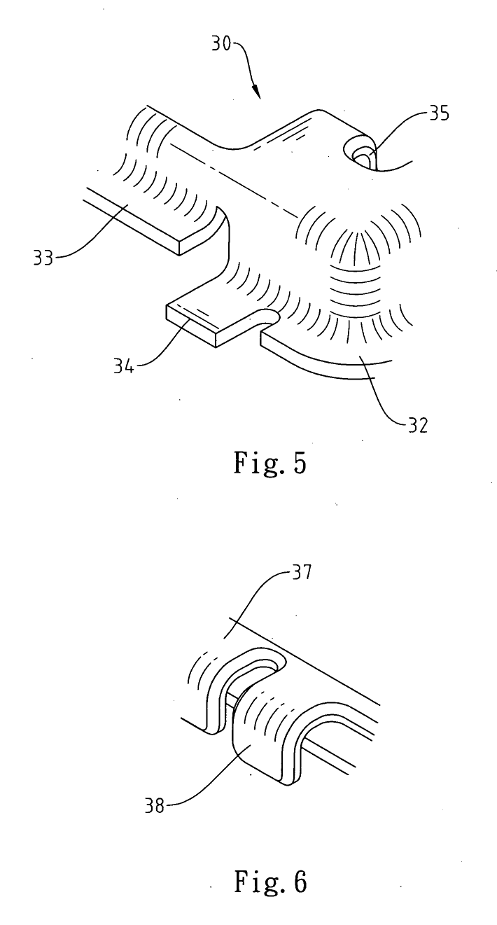

Please refer to the figures from FIG. 2 to FIG. 6. The present invention is mainly a cover case 30, a metal product from a one-time integrated stamping process, also a cover frame that can cover a base 40. The cover case 30 has a holding section 31 in the middle for connection to an ultra-fine wire coaxial connector. The bottom of the cover case 30 is surrounded by base edges 32 on two lateral sides and the backside, so it sits securely on the substrate board. At the front, there is a convex edge 33 curving up forward to form a protective device. On one side of the convex edge 33, there is one ground tab 34. On the other side, there is a corresponding matching ground tab 34. On each side of the front interior of the holding section 31, there is a curved positioning tab 35. In the rear interior of the holding section 31, there is a bending section 37 with several dividers 36. The dividers 36 divide the bending section 37 into several parts to enhance the fastening effect. On each exterior side of the bending section 36, there is a position limiter 38, which has a small curvature and possesses elasticity and position limiting effect.

The base 40 has a corresponding holding section 41 to the holding section 31 of the cover case 30. The front of the holding section 41 has several terminals 42. There are also corresponding positioning grooves 43 to the positioning tabs 35 for placement and positioning. The rear of the holding section 41 has bumps 44 corresponded to the dividers 36 of the cover case 30 for positioning. There are also position-limiting grooves 45 corresponded to the position limiting tabs 38 for the secondary positioning. The position-limiting groove 45 provides a hand feeling to lock the position limiters 38.

Please refer to the figures from FIG. 2 to FIG. 6 again. The cover case 30 for the present invention covers the base 40 so that the holding section 31 of the cover case 30 superimposes on the holding section 41 of the base 40. The positioning tab 35 of the cover case 30 is inserted in the positioning groove 43 of the base 40. The bending section 37 of the cover case 30 is fastened to the base 40 and positioned by the interaction between the dividers 36 of the cover case 30 and the bumps 44 of the base 40. Finally, the position limiting tabs 38 of the cover case 30 are inserted in the position-limiting groove 45 of the base 40 for the secondary positioning. In this way, the cover case 30 is securely fastened to the base 40. The position-limiting tabs 38 of the cover case 30 have small curvature, elasticity and position limiting effect.

Therefore, the present invention has the following advantages:

1. The present invention is accomplished by a one-time integrated stamping process for a base edge, a convex edge, a bending section with dividers, several position limiters, several positioning tabs and several ground tabs to reduce manufacturing cost.

2. Since the present invention is based on one-time integrated stamping process, it tends to minimize stress variation and maintain strength, so cover strength and protective ability can be enhanced.

3. Since the present invention does not need a slot as in traditional connector, the assembly workers do not need to worry about being cut.

4. The present invention does not need to punch a concave section near the bending section before bending operation.

5. Since the positioning tab in the present invention has smaller curvature, it has elasticity and position limiting effect. The position-limiting groove provides a hand feeling for the position limiter to lock.

1. A seamless cover case from a stamping process to cover a base; the bottom of the cover case is surrounded by base edges on two lateral sides and the backside; in the front interior of the cover case, it is a one-time integrated stamping process to make several bent positioning tabs, a bending section with dividers and several elastic position limiters outside the bending section.

2. As described in claim 1 for a seamless cover case, there is a convex edge at the front of the cover case bottom.

3. As described in claim 1 for a seamless cover case, the cover case bottom edge has several ground tabs curving up forward to form protective devices and located at the lateral sides of the convex edge.

4. As described in claim 1 for a seamless cover case, the base has a positioning groove, bumps and a position limiting groove for connection with positioning tabs, dividers and position limiters to enable a secure fastening of the cover case to the base.
